(19) United States
(12) Patent Application Publication
(10) Pub. No.: US 2024/0262483 A1
(43) Pub. Date: Aug. 8, 2024

(54) VESSEL PROVIDED WITH AN IMPROVED AIR CIRCULATION SYSTEM

(71) Applicant: 3J MARINE S.R.L., Roma (RM) (IT)

(72) Inventors: Andrea ALFANO, Angri (SA) (IT); Giancarlo RAIOLA, Angri (SA) (IT)

(21) Appl. No.: 18/567,168

(22) PCT Filed: Jun. 28, 2022
(86) PCT No.: PCT/IB2022/055991

§ 371 Date: Dec. 5, 2023

(30) Foreign Application Priority Data
Jun. 29, 2021 (IT) 102021000017057

(51) Int. Cl. B63J 2/10; B63J 2/04; B63J 2/06

(52) U.S. Cl. CPC B63J 2/10; B63J 2/04; B63J 2/06

(57) ABSTRACT

A vessel having an air circulation system allowing better exploitation of the spaces inside the vessel is provided. The flanks of the hull of the vessel are used for accommodating at least part of the components of the air circulation system to free up useful space on decks, in order to use it for other purposes. Porthole frames are used for making air ports for the ventilation and air conditioning system to simplify the design of the system and not to deteriorate the outer appearance of the hull.

### TECHNICAL FIELD

The present invention relates to a vessel provided with an air circulation system.

More particularly, the present invention relates to a vessel provided with an air circulation system allowing the best possible use of space inside the vessel.

Said ventilation system can advantageously be used for the air circulation in the engine room of the vessel, and particularly for the ventilation of the engine room, but also for the air circulation in other rooms, such as, for example, the rooms of the vessel that are intended for passengers' use.

In addition, said air circulation system can also be used for extracting air from rooms of the vessel, for example for extracting hot air from the engine room, and/or for air conditioning of rooms of the vessels, such as, for example, those that are intended for passengers' use.

### BACKGROUND ART

Referring also to FIGS. 1-3, in the state of the art, vessels 100 are known comprising a hull 102 and a main deck 104 on which a superstructure 106 is provided capable of housing, for example, the helm station of the vessel.

Inside the hull 102, the space is divided in one or more overlying decks 108, 110, which accommodate other rooms, the intended use of which will depend on the kind of vessel, and further accommodate the rooms for the crew, the engine room, rooms for the storage and conservation of materials, and so on.

FIGS. 1-3 illustrate, by way of example, a pleasure craft 100 and the decks 108, 110 will partially be used as areas available for passengers (so-called “noble areas”).

More in detail, FIG. 1 shows a pleasure craft 100 comprising, below the main deck 104, a middle deck 108 (usually referred to as “lower deck” in the technical field of reference) and a lowermost deck (usually referred to as “underlower deck” in the technical field of reference): the “lower deck” 108, located immediately below the main deck, may accommodate—among others—rooms for passengers' and crew's use, whereas the “underlower deck” 110, located immediately above the keel of the hull, usually accommodates the engine room, storage rooms and the like.

In general, in pleasure crafts of the known type, the engine room usually extends upwards beyond the underlower deck 110 and up to the main deck, thus partially occupying also the “lower deck” 108 and taking space from the passengers' rooms.

Since the engine room is located at the lowermost deck of the vessel, in a closed environment, proper ventilation of the machinery contained therein is of utmost importance and cannot but take place by means of a forced ventilation system.

For this reason, vessels must necessarily be equipped with an appropriate ventilation system for the engine room.

Preferably, vessels are also provided with a system for extracting air from the engine room, in order to extract hot air from the engine room, so as to subtract heat and help to keep the temperature of the machinery contained therein limited.

In addition to a ventilation system for the engine room, the vessel may further be provided—depending on its intended use—with further ventilation systems for other rooms, or also with air conditioning systems. This is the case, for example, with passenger vessels, in which the rooms available for the passengers are provided with an air conditioning system. However, ventilation, air extraction and air conditioning systems commonly used according to prior art have remarkable drawbacks.

In particular, as clearly shown in FIGS. 2 and 3, in the making of an air circulation system 200, it is necessary to provide rooms intended for housing the blowers and promoting forced air circulation, as well as an arrangement of air ducts 202, 204 carrying air into the different rooms to be ventilated or conditioned through the different decks of the vessel.

As can be seen in FIG. 2, according to prior art, blowers are provided at both sides of the hull, each blower having its own arrangement of ducts 202, 204.

As can be seen in FIG. 1, each arrangement of ducts 202 comprises an air port 206, which is normally formed above the level of the main deck 104.

For example, said air port can be formed in a corresponding funnel extending upwards from the main deck (in this respect see, for example, document KR 101654595, especially with reference to the funnel indicated with 130).

Correspondingly, the relative arrangements of ducts 202, 204 as well as the rooms intended for housing the blowers are formed at the noble areas provided on said decks, thus taking useful space from the rooms intended for passengers.

Even in case of vessels intended for a use other than the transport of passengers, the air circuits of air circulation systems take remarkable space that could more profitably be put to other uses.

In other words, if the aforementioned drawback is particularly felt with pleasure crafts, where a strong need is felt to guarantee comfortable cabins and large leisure, recreational spaces for the passengers, it is also present in vessels of other kinds: irrespective of the final destination thereof, because of the limited overall space available, optimization in managing the rooms is one of the key points when designing any kind of vessel.

Furthermore, the operation of the air circulation system 200 generates some noise, whereby it is necessary to provide for the acoustic insulation of said system, especially in vessels for transporting passengers.

The object of the present invention is therefore to overcome the drawbacks of prior art, by providing a vessel having an air circulation system that allows eliminating, or at least drastically limiting, the space occupied on the decks of the vessel itself and thus taken from other uses.

Another object of the present invention is to provide a vessel equipped with an air circulation system that allows eliminating, or at least reducing, the need to provide dedicated apparatuses for acoustic insulation.

These and other objects are achieved with a vessel as claimed in the appended claims.

### SUMMARY OF INVENTION

The invention provides for moving the components of the air circulation system towards the flanks of the vessel, so as to free up useful space on the decks, in order to use it for other purposes.

In particular, the invention provides for using the structure of the vessel hull for housing the ducts of the air circulation system.

In this way, it will be possible for the blowers of said air circulation system to be accommodated on the lowermost deck of the vessel, near the flanks of the vessel itself, and the air ducts will develop inside the hull of the vessel, between each of said blowers and a corresponding air port provided on the flank of the vessel.

Preferably, said air ducts will develop entirely inside the hull of the vessel between each of said blowers and a corresponding air port provided on the flank of the vessel.

In this way, the space requirement of the air circulation system at the decks of the vessel will be close to zero.

Even in the case in which the air circulation system is used for ventilating rooms located in central areas of the decks, or for conditioning air in said rooms, the space requirement of said air circulation system is limited to the distribution ducts necessary for reaching the rooms to be ventilated and/or conditioned.

Advantageously, according to the invention, frames of the type usually employed for mounting portholes generally present on the flanks of the vessel are used for making the air ports for the air circulation system.

Real portholes or so-called “fake portholes”, which have a simple glass facing outwards and are closed inwards, can then be mounted inside said frames.

This solution has apparent advantages.

First of all, by using elements which are traditionally already provided on vessels, the designing of the air circulation system will be simplified.

Secondly, by using porthole frames rather than providing dedicated air ports covered by protective grids or the like, the invention can also be implemented in vessels in which the outer appearance of the hull is of great importance, such as, for example, luxury pleasure crafts.

The air circulation system thus conceived can advantageously be used for ventilating the engine room of the vessel.

In this respect, it will be of advantage to provide for arranging the blowers of said air circulation system directly within the engine room.

However, said air circulation system can also be used for extracting hot air from the engine room.

In particular, by providing use of a reversible blower, the direction of the air flow in the circuit of the air circulation system can be reversed as required, so that ventilation of the engine room or air extraction therefrom can be obtained alternatively.

In addition, the air circulation system according to the invention can also be used for the ventilation and/or air conditioning of other rooms of the vessel. For example, in the case of pleasure crafts, it can be used for the air conditioning of the rooms used by passengers.

### BRIEF DESCRIPTION OF DRAWINGS

Further features and advantages will become more evident from a detailed description of some preferred embodiments of the invention, provided by way of non-limiting example with reference to the annexed drawings, in which:

FIG. 1 is a schematic view of a pleasure craft according to prior art;

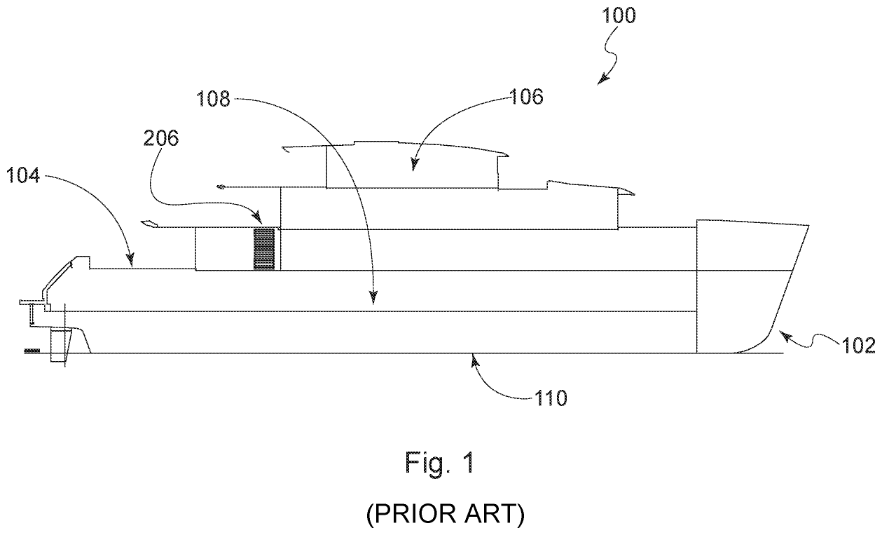

FIG. 2 is a plan view of a portion of a deck of the vessel of FIG. 1;

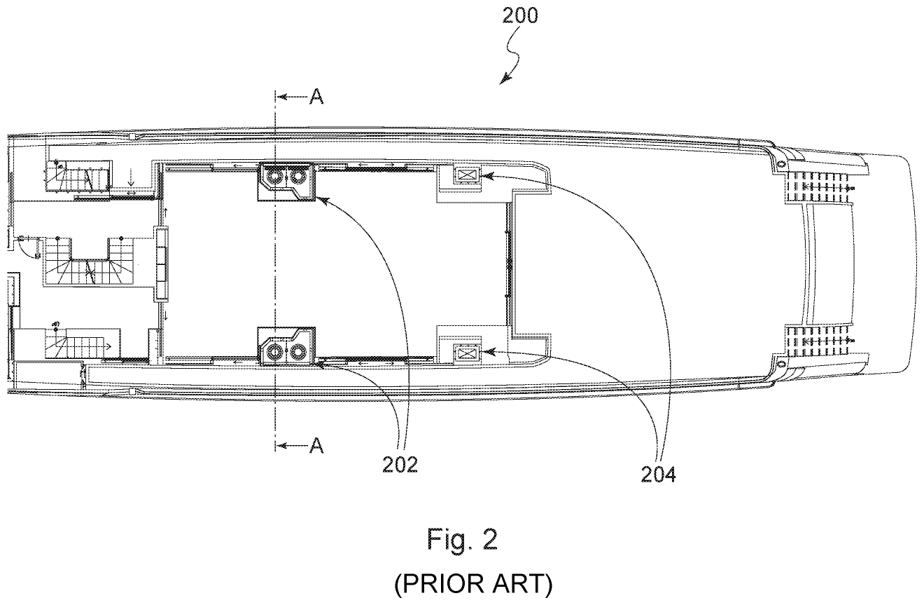

FIG. 3 is a cross-sectional view along line A-A of the deck of the vessel of FIG. 2;

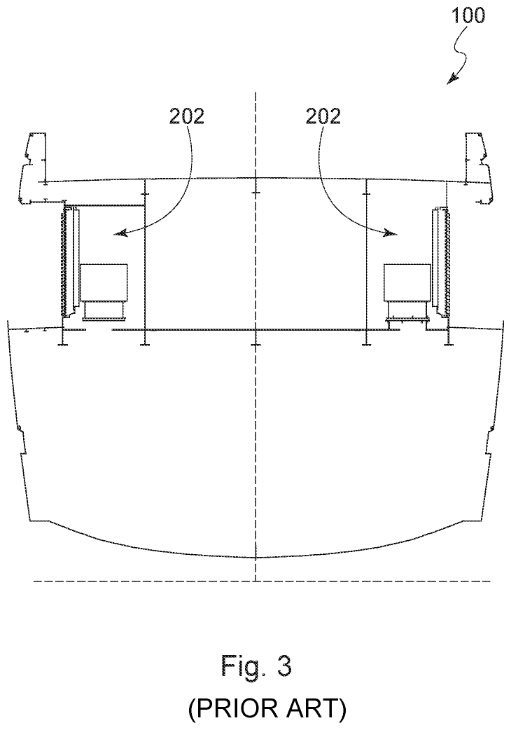

FIG. 4 is a schematic view of a pleasure craft incorporating an air circulation system according to the invention;

FIG. 5 is a plan view of a portion of a deck of the vessel of FIG. 4;

FIG. 6 is a cross-sectional view along line A-A of the deck of the vessel according to FIG. 2;

FIG. 7 is a schematic perspective view showing a portion of the hull of a vessel according to the invention, which portion accommodates components of the air circulation system according to a first embodiment of the invention;

FIG. 8 is a schematic front view of the hull portion of FIG. 7;

FIG. 9 is a schematic perspective view showing a portion of the hull of a vessel according to the invention, which portion accommodates components of the air circulation system according to a second embodiment of the invention;

FIG. 10 is a schematic front view of the hull portion of FIG. 9.

### DESCRIPTION OF EMBODIMENTS

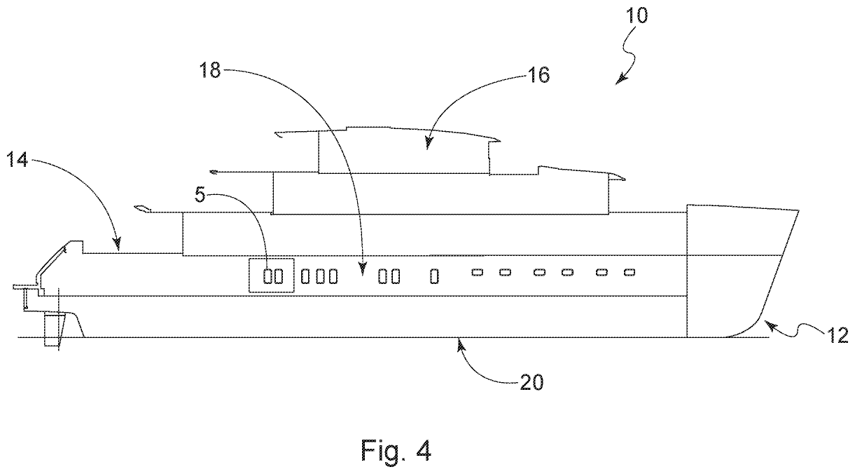

Here below, reference will be made to a pleasure craft 10 of the type shown in FIGS. 4-6.

However, the invention should not be understood as being limited to this type of vessels and can be implemented in any types of vessels.

In general, the invention is applicable to vessels of the type comprising a main deck 14 and a hull 12 the interior of which is divided in a plurality of overlying decks 18, 20.

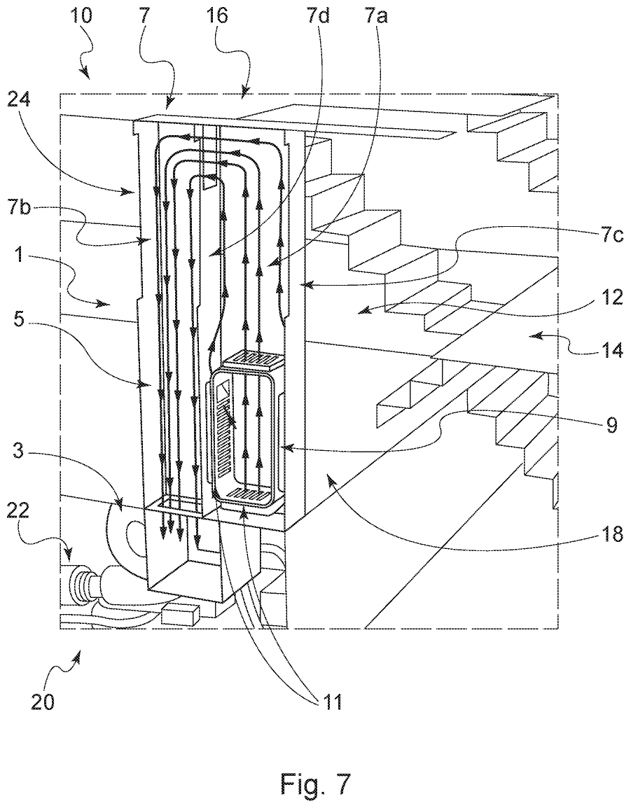

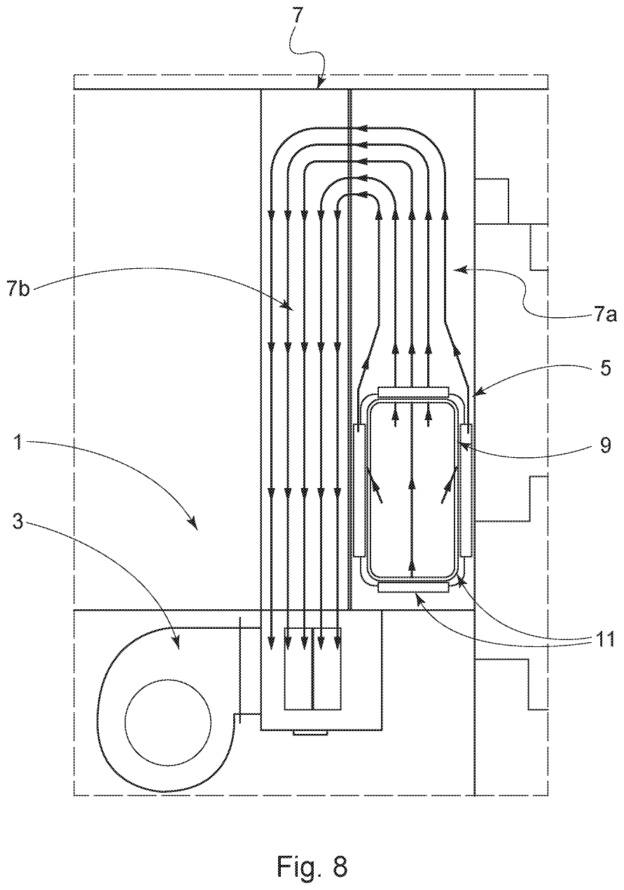

Referring to FIGS. 7 and 8, there is schematically illustrated a portion of the hull 12 of a vessel 10 according to the invention.

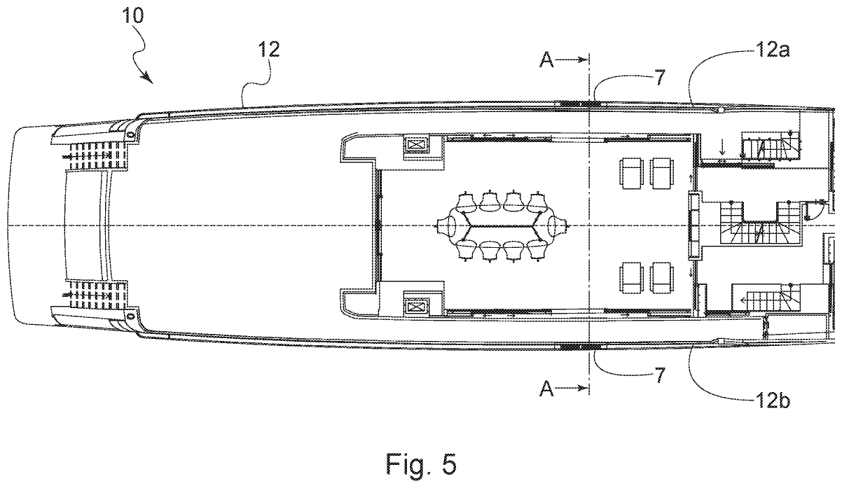

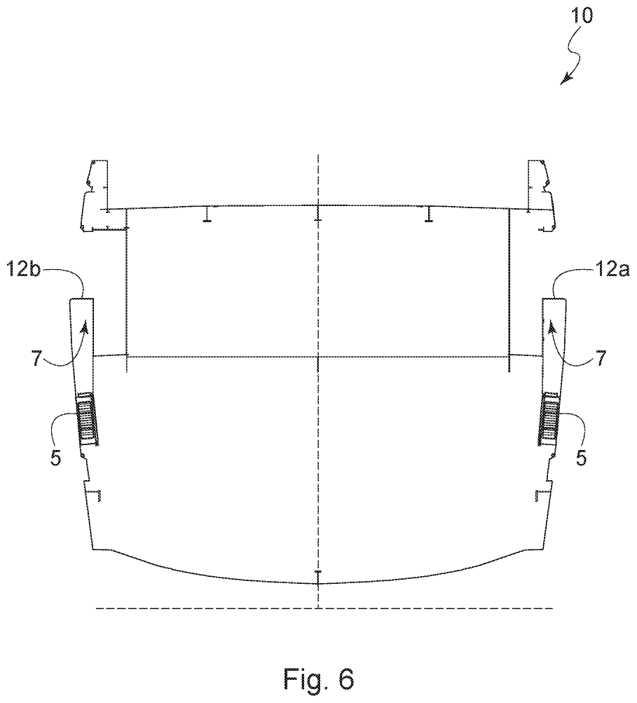

The hull 12 comprises a pair of flanks 16a, 16b (see FIGS. 5 and 6) extending from the bow end to the stern end on the opposite sides of the vessel 10. Each of said flanks 16a, 16b comprises an outer wall, an inner wall and a space sandwiched between said outer wall and said inner wall.

A main deck 14, on which a superstructure 16 is arranged, and one or more decks 18, 20 located below the main deck 14 and inside the hull 12 extend between the opposite flanks of the hull 12.

More particularly, the space inside the hull is divided in two overlying decks, a “lower deck” (or middle deck) 18, which is located immediately below the main deck, and an “underlower deck” (or lowermost deck) 20, which is immediately above the keel of the hull 12.

In a manner known per se, in the “underlower deck” 20 there is provided the engine room 22, which houses the machinery necessary for propelling the vessel.

It should be noted that, according to the type and size of the vessel 10, the engine room 22 might extend in height beyond the ceiling of the “underlower deck” and occupy part of the overlying deck.

In the ensuing detailed description, reference will be made to the use of the air circulation system according to the invention as a ventilation system for the engine room of the vessel.

However, such reference should not be understood as limiting, and the system according to the invention can also be used as a ventilation system for rooms other than the engine room, as a system for extracting air from the engine room or other room, and also as an air conditioning system.

As mentioned above, proper ventilation of the engine room 22 is of primary importance for the safety of the vessel, as well as for the performance thereof and the useful life of the machinery contained therein.

Accordingly, the vessel will be equipped with an air circulation system 1 for ventilating the engine room 22.

Generally, said ventilation system 1 comprises:
one or more blowers 3 arranged to promote forced air circulation;
for each of said blowers 3, at least one air port, in particular an air inlet port or air intake 5;
air passage ducts, in particular air supply ducts 7, which connect said at least one air intake 5 to the respective blower 3;
air distribution ducts (not shown) which carry air from the blower 3 to the rooms to be ventilated.

According to the invention, said at least one air intake 5 is located on the outer wall of a flank of the hull 12 (see also FIG. 4) and the air supply ducts 7 develop inside the space sandwiched between the outer wall and the inner wall of said flank of the hull 12, between the air intake 5 and the blower 3 (see also FIGS. 5 and 6).

Preferably, said air supply ducts 7 develop entirely inside the space sandwiched between the outer wall and the inner wall of said flank of the hull 12, between the air intake 5 and the blower 3.

Said blower if preferably located on the lowermost deck of the vessel (in the present case, the “underlower deck” 20), and even more preferably inside the engine room 22.

Preferably, one or more blower(s) 3 (and corresponding air intake(s) 5) will be provided for each flank of the hull 12.

This will advantageously allow limiting the extension of the air distribution ducts for reaching the different rooms to be ventilated.

It should be noted that, as anticipated above, the system according to the invention could be used for the making of a system for extracting air from the engine room.

In this case, the blower(s) will be arranged for sucking air from the engine room, and the air port will be used as an air outlet port or air vent, and the air passage ducts will be used as air discharge ducts.

For example, it would be possible to provide an air circulation system according to the invention operating as a ventilation system for the engine room, on one side of the vessel, and a similar air circulation system according to the invention operating as a system for extracting air from the engine room, on the opposite side of the vessel.

Alternatively, by providing blowers in which the direction of the air flow can be reversed, the same system according to the invention can be used alternately for blowing fresh air into (ventilating) the engine room or for extracting hot air therefrom.

Referring again to the shown embodiment, the air intake 5 is arranged on the outer wall of the flank of the hull, at a position located below the freeboard deck, which usually coincides with the main deck 14.

For this reason, the air supply ducts 7 will have a first, upwardly oriented branch 7a, which extends from the air intake 5 above the main deck 14, inside the bulwark 24 of the hull 12, and a second, downwardly oriented branch 7b, which extends from the main deck 14 to the blower 3.

As shown in FIGS. 7 and 8, the first, upwardly oriented branch 7a and the second, downwardly oriented branch 7b can be obtained in a same housing 7c, on condition that they are divided by a partition 7d.

This prevents water coming from the outside through the air intake 5 from penetrating into the second, downwardly oriented branch 7b of the air supply ducts 7 and reaching, from there, the blower 3.

In the embodiment shown in FIGS. 7 and 8, the first, upwardly oriented branch 7a and the second, downwardly oriented branch 7b are arranged side-by-side and aligned in the longitudinal direction of the hull 12.

However, in an alternative embodiment of the invention, the first, upwardly oriented branch 7a and the second, downwardly oriented branch 7b might also be arranged side-by-side and aligned in the transverse direction of the hull 12.

Advantageously, the invention provides for using porthole frames 9 for the making of the air intake 5.

To this aim, slits 11 for air entrance are provided on one or more sides—preferably on all sides—of the porthole frame 9.

Said slits 11 might possibly be provided with means for preventing passage of water splashes, allowing only air to penetrate into the air supply ducts 7.

Using porthole frames 9 for the making of air intakes will not allow simplifying the designing of the ventilation system by using already present and available components, but it will also make it possible not to damage the outer appearance of the hull, this being a need felt with passengers' vessels, especially with luxury pleasure crafts.

The porthole frames 9 used for the making of air intakes should not necessarily be provided with a real porthole. They might also hold a so-called “fake porthole”, comprising a glass on the side of the hull facing outwards and a metal sheet on the side of the hull facing inwards.

With this solution, too, which is remarkably more cost-effective than the use of real portholes, the uniformity of the outer appearance of the hull wall will be homogeneous.

Inside, the metal sheet will then be covered with covering materials used for the rest of the inner wall of the hull.

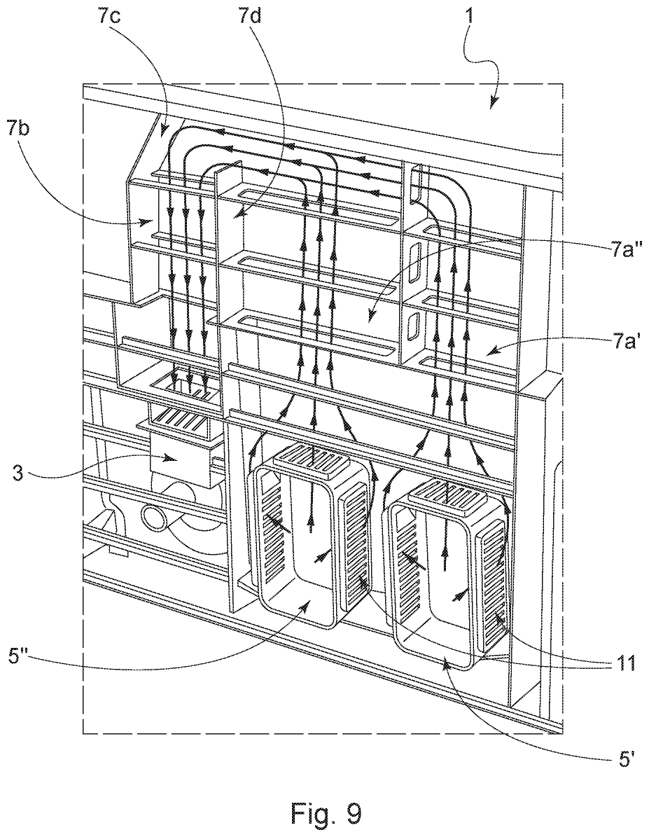

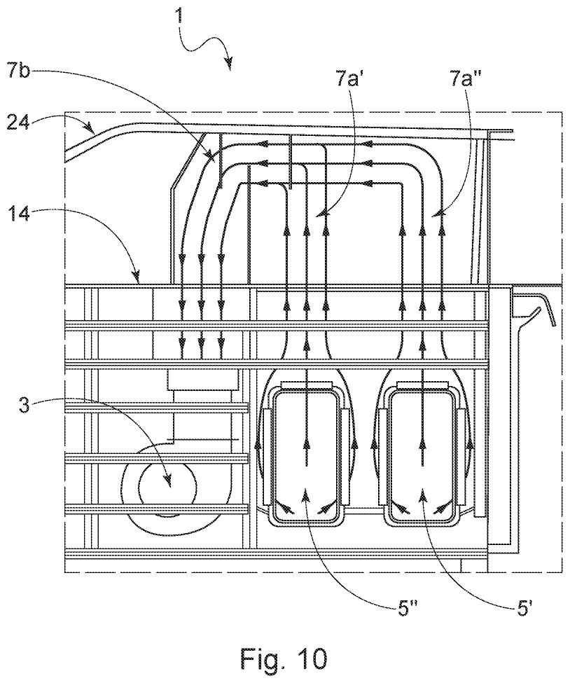

Turning now to FIGS. 9 and 10, there is shown a second embodiment of the invention. Said second embodiment is substantially similar to the one shown in FIGS. 7 and 8. For this reason, the same reference numerals already used before will be used for identifying identical or similar components, and such components will not be described in detail again. The embodiment of FIGS. 9 and 10 differs from the previously described one in that two different air ports (in the shown embodiment, air intakes) 5′, 5″, both provided on the outer wall of a flank of the hull, are associated with each blower.

Accordingly, the air supply ducts comprise two upwardly oriented branches 7a′, 7a″ associated each to a corresponding air intake. Said upwardly oriented branches 7a′, 7a″ then merge into a common downwardly oriented branch 7b leading to the blower 3. Both the two upwardly oriented branches 7a′, 7a″ and the downwardly oriented branch 7b develop inside the space sandwiched between the outer wall and the inner wall of the flank of the hull. In particular, they develop entirely inside the space sandwiched between the outer wall and the inner wall of the flank of the hull.

In this embodiment, too, the downwardly oriented branch—rather than being arranged side-by-side and aligned with the upwardly oriented branches in the longitudinal direction of the hull, as shown in the Figures—might be arranged side-by-side and aligned with the upwardly oriented branches in the transverse direction of the hull.

It will be apparent to the person skilled in the art that the detailed description above has been provided by way of non-limiting example and that several variations and modifications are possible without thereby departing from the scope of protection as defined in the appended claims.

In particular, although in the embodiments described above reference has been made to the use of the ventilation system for ventilating the engine room, it may also be used for ventilating other rooms, for extracting air from the engine room or other rooms, or also for conditioning air in other rooms.

In particular, a vessel may be provided with several ventilation systems according to the invention, each with its own destination of use. For example, a first ventilation system for ventilating the engine room, a second ventilation system for extracting air from the engine room, a third ventilation system for air conditioning in the areas intended for passengers, a fourth ventilation system for ventilation (or air conditioning) in the crew's rooms, and so on, can be provided.

Furthermore, although in the embodiments shown above reference has sometimes been made to a pleasure craft, the ventilation system according to the invention can be implemented in any kinds of vessels.

1: A vessel comprising a main deck and a hull, and further comprising one or more decks arranged below said the main deck and inside the hull, wherein the hull comprises a bow, a stem, and a pair of flanks extending from the bow to the stem on opposite sides of the vessel, each of the flanks comprising an outer wall, an inner wall and a space sandwiched between the outer wall and the inner wall, wherein the vessel comprises rooms to be ventilated, wherein the vessel has an air circulation system, wherein the air circulation system comprises:
one or more blowers intended to promote forced air circulation;
for each blower of the one or more blowers, one or more air ports;
air passage ducts connecting each of the one or more air ports to a respective one of the one or more blowers; and
air distribution ducts conveying air from the one or more blowers to the rooms to be ventilated or vice versa,
wherein, for each blower of the one or more blowers, the one or more air ports are arranged on the outer wall of one of the pair of flanks of the hull and the air passage ducts extend inside a space sandwiched between the outer wall and the inner wall of the flank, between each air port of the one or more air ports and the respective one of the one or more blowers.

2. (canceled)

3: The vessel according to claim 1, wherein the one or more blowers, with the respective air ports and the respective air passage ducts, are provided at each of the flanks of the hull.

4: The vessel according to claim 1, wherein a freeboard deck is defined in the hull of the vessel and the one or more air ports are arranged on the outer wall of the respective flank of the hull at a position located below the freeboard deck.

5: The vessel according to claim 4, wherein the freeboard deck coincides with the main deck and the one or more air ports are arranged on the outer wall of the respective flank of the hull at a position located below the main deck.

6: The vessel according to claim 5, wherein the air circulation system comprises, for each blower, an one of the air ports, and wherein the air passage ducts comprise a first, upwardly oriented branch, which extends from the air port up to above the main deck and has a top end located above the main deck, and a second, downwardly oriented branch, which extends from the top end of the upwardly oriented branch.

7. The vessel according to claim 6, wherein the hull is provided with bulwark upwardly extending above the main deck, and the first, upwardly oriented branch of the connecting ducts extends within the bulwark of the hull.

8: The vessel according to claim 6, wherein the hull has a longitudinal direction and a transverse direction, and wherein the second, downwardly oriented branch of the connecting ducts is arranged side-by-side and aligned with the first, upwardly oriented branch of the connecting ducts in the longitudinal direction of the hull.

9: The vessel according to claim 6, wherein the hull has a longitudinal direction and a transverse direction, and wherein the second, downwardly oriented branch of the connecting ducts is arranged side-by-side and aligned with the first, upwardly oriented branch in the transverse direction of the hull.

10: The vessel according to claim 1, wherein the air circulation system comprises, for each blower of the one or more blowers, several of the air ports.

11: The vessel according to claim 10, wherein said a freeboard deck is defined in the hull of the vessel and wherein for each blower of the one or more blowers, the air ports are arranged on the outer wall of the respective flank of the hull at a position located below the freeboard deck.

12: The vessel according to claim 11, wherein the freeboard deck coincides with the main deck and said wherein for each blower of the one or more blowers, the air ports are arranged on the outer wall of the respective flank of the hull at a position located below the main deck.

13: The vessel according to claim 12, wherein, for each blower of the one or more blower and for each air port of the several air ports, the air passage ducts comprise a first, upwardly oriented branch which extends from the air ports up to above the main deck and has a top end located above the main deck, and a second, downwardly oriented branch, which extends from the top end of the upwardly oriented branches to the respective blower.

14: The vessel according to claim 13, wherein the hull is provided with bulwark upwardly extending above the main deck, and the first upwardly oriented branches of the connecting ducts extends within the bulwark of the hull.

15: The vessel according to claim 13, wherein the hull has a longitudinal direction and a transverse direction, and wherein the second, downwardly oriented branch of the connecting ducts is arranged side-by-side and aligned with the first, upwardly oriented branches of the connecting ducts in the longitudinal direction of the hull.

16: The vessel according to claim 13, wherein the hull has a longitudinal direction and a transverse direction, and wherein the second, downwardly oriented branch is arranged side-by-side and aligned with the first, upwardly oriented branches of the connecting ducts in the transverse direction of the hull.

17: The vessel according to claim 1, wherein the air passage ducts connecting each air port of the one or more air ports to the respective blower develop entirely inside the space sandwiched between the outer wall and the inner wall of the respective flank of the hull.

18: The vessel according to claim 1, wherein the one or more air ports are made by using a porthole frame, slits for air inlet being provided at one or more sides of the porthole frame.

19: The vessel according to claim 1, wherein the vessel comprises an engine room received in one of the decks arranged inside the hull, and wherein the one or more blowers are arranged in the engine room.

20: The vessel according to claim 1, wherein the vessel comprises several decks arranged inside the hull and stacked on one another, and wherein the one or more blowers are arranged in a lowermost deck of the several decks arranged inside the hull.
